(19) United States
(12) Patent Application Publication
(10) Pub. No.: US 2020/0158985 A1
(43) Pub. Date: May 21, 2020

(54) LENS MODULE

(71) Applicant: AAC Optics Solutions Pte. Ltd., Singapore city (SG)

(72) Inventor: Lingyun Xu, Shenzhen (CN)

(21) Appl. No.: 16/686,235

(22) Filed: Nov. 18, 2019

(30) Foreign Application Priority Data
Nov. 19, 2018 (CN) 201821910656.7

(51) Int. Cl. G02B 7/02

(52) U.S. Cl. CPC G02B 7/021; G02B 13/003

(57) ABSTRACT

The present disclosure provides a lens module, including a lens barrel, a lens group and locating blocks. The lens barrel includes a first barrel wall and a second barrel wall, the lens group includes at least one first lens. The first lens includes a body portion and a peripheral portion, the peripheral portion is disposed opposite to the first barrel wall, and the peripheral portion includes an object-side surface and an image-side surface disposed opposite to each other, and a connecting surface connecting the object-side surface and the image-side surface. Compared with the related art, the lens module of the present disclosure has a simple structure, is convenient to adjust, and has good reliability.

### TECHNICAL FIELD

The present disclosure relates to the field of optical imaging, and more particularly to a lens module used in the field of photographing products.

### BACKGROUND

With the continuous development of science and technology, electronic devices are continuously developed towards intelligence. In addition to digital cameras, portable electronic devices such as tablet computers and mobile phones are also equipped with lens modules having photographing and image shooting functions, so as to meet the photographing needs of users at any time.

A lens module in the related art includes a lens barrel and a lens group, an accommodating space is provided in the lens barrel, the lens barrel is accommodated and fixed in the accommodating space, and the lens barrel includes a first barrel wall encircling a light through hole and a second barrel wall bending and extending from an edge of the first barrel wall towards an image side along an optical axis direction. The lens group includes at least one lens. The lens includes a body portion serving as an imaging area and a peripheral portion outwards extending surrounding the body portion, and the first barrel wall is covered on the peripheral portion.

However, in the related art, during the assembly process of the lens barrel and the lens group, the first barrel wall and the peripheral portion are directly jointed, which is extremely easy to cause assembly deformation, and increases the matching and molding difficulty of the lens barrel and the lens group, and is not conducive to the optical performance and reliability of the lens module.

Therefore, it is necessary to provide a novel lens module to solve the above-mentioned problems.

### BRIEF DESCRIPTION OF THE DRAWINGS

In order to illustrate the technical solutions in the embodiments of the present disclosure more clearly, the drawings used in the description of the embodiments will be briefly described below. Obviously, the drawings in the following description are merely some embodiments of the present disclosure. Those of ordinary skills in the art can also obtain other drawings according to these drawings without going through any creative work, wherein:

FIG. 1 is a schematic structure diagram of a lens module according to the present disclosure; and

FIG. 2 is an enlarged view shown in portion A of FIG. 1.

### DETAILED DESCRIPTION

The following clearly and completely describes the technical solutions in the embodiments of the present disclosure with reference to the accompanying drawings in the embodiments of the present disclosure. Apparently; the described embodiments are merely some but not all of the embodiments of the present disclosure. Based on the embodiments of the present disclosure, all other embodiments obtained by those of ordinary skills in the art without going through any creative work shall fall within the scope of protection of the present disclosure.

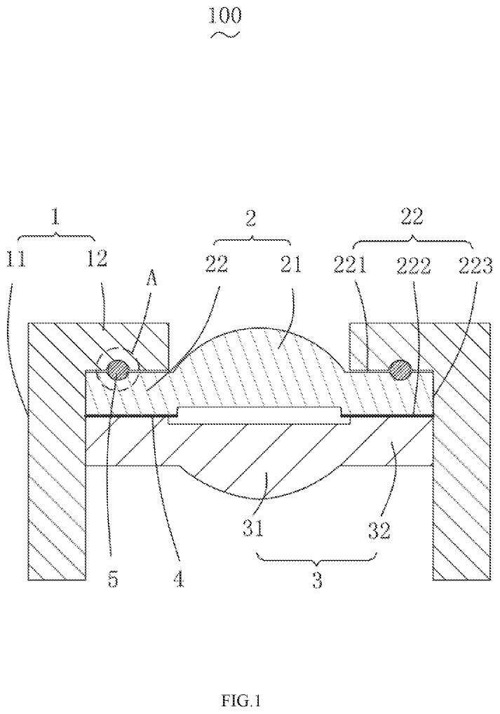

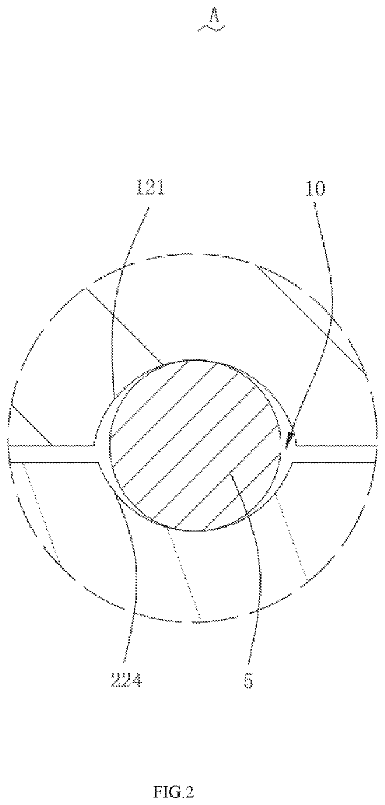

Referring to FIG. 1 and FIG. 2, the present disclosure provides a lens module 100; including a lens barrel 1, a first lens 2 and a second lens 3 accommodated in the lens barrel 1 from an object side to an image side, a shade 4 sandwiched between the first lens 2 and the second lens 3; and balls 5.

The lens barrel 1 includes a first barrel wall 12 encircling a light through hole and a second barrel wall 11 bending and extending from an edge of the first barrel wall 12 towards the image side along an optical axis direction.

The lens module 100 at least includes a first lens 2. In this embodiment, the lens module is explained by taking only two lenses as an example. The lens module may include three or more lenses, and the same principle is applicable to any lens module.

The first lens 2 includes a body portion 21 serving as an imaging area and a peripheral portion 22 outwards extending surrounding the body portion 21.

The body portion 21 is in an arc-shaped structure, such as a spherical structure, an aspherical structure, and the like, and is used for imaging. The peripheral portion 22 is used for bearing.

Similarly, the second lens 3 includes a second body portion 31 serving as an imaging area and a second peripheral portion 32 outwards extending surrounding the second body portion 31.

The peripheral portion 22 is disposed opposite to the first barrel wall 12, and the peripheral portion 22 includes an object-side surface 221 and an image-side surface 222 disposed opposite to each other, and a connecting surface 223 connecting the object-side surface 221 and the image-side surface 222.

In this embodiment, the connecting surface 223 is abutted against the second barrel wall 11, that is, the peripheral portion 22 and the second barrel wall 11 are completely jointed.

One side of the first barrel wall 12 close to the first lens 2 is recessed towards a direction far away from the peripheral portion 22 to form a first recess 121. The object-side surface 221 is recessed towards the image-side surface 222 to form a second recess 224. An orthographic projection of the first recess 121 on the second recess 224 coincides with the second recess 224. The first recess 121 and the second recess 224 jointly enclose an accommodating space 10. Locating blocks are accommodated in the accommodating space 10.

The locating blocks are balls 5 which are clamped in the accommodating space 10 and enable the first barrel wall 12 to be spaced apart from the peripheral portion 22. A gap reserved between the first barrel wall 12 and the peripheral portion 22 can reduce the matching and molding difficulty of assembling the lens barrel and the lens group, reduce the assembly deformation and improve the assembly yield. The locating blocks may also be rollers or other structures as long as the locating blocks can be accommodated in the accommodating space 10 and avoids mutual extrusion between the first barrel wall 12 and the peripheral portion 22.

Specifically, the first recess 121 and the second recess 224 encircling the accommodating space 10 are both in arc-shaped structures. The balls 5 are symmetrically arranged along a circumferential direction of the peripheral portion 22. The rolling connection structure enables the overall stability of the lens module to be stronger.

More preferably, the balls 5 are equally spaced, so that the overall stability the lens module is further improved.

Of course, a plurality of the first recesses 121 may also be provided and spaced apart from each other, the number of the second recess 224 is matched with the first recess 121, the first recess 121 and the second recess 224 are disposed opposite to jointly enclose one accommodating space 10. Pluralities of balls 5 are provided, and each ball 5 is clamped in one accommodating space 10. The plurality of rolling connection structures added can better reduce the assembly deformation in the assembly process of the lens barrel and the lens group, and meanwhile, reduce the matching and molding difficulty of the lens barrel and the lens group, and improve the overall stability of the lens module.

Moreover, the lens module 100 further includes a shade 4 sandwiched between the peripheral portion 22 and the second peripheral portion 32. The shade 4 is used to improve false light, so that the optical performance of the lens module 100 is better.

Specifically, the shade 4 is press-molded, which has high production efficiency, good reproducibility of products and stable quality.

Compared with the related art, the lens module of the present disclosure is provided with the recess structures on the inner side of the first barrel wall and one side of the peripheral portion of the first lens close to the object side, the two recess structures are disposed opposite to each other, and the locating blocks are disposed in the space formed by the two recesses, clamped in the accommodating space and enable the first barrel wall to be spaced apart from the peripheral portion. Due to a certain gap between the first barrel wall and the peripheral portion in the assembly process of the lens module with such a structure, the assembly deformation can be reduced, and the matching and molding difficulty between the lens barrel and the lens group can be reduced; and meanwhile, the lens module is only added with the locating blocks for clamping, so that the lens module has a simple structure, and is also convenient to adjust, and has good optical performance and reliability finally.

The description above is merely the embodiments of the present disclosure, and it should be pointed out that those of ordinary skills in the art may make improvements without departing from the concept of the present disclosure, and all these improvements shall belong to the scope of protection of the present disclosure.

What is claimed is:

1. A lens module, comprising
a lens barrel, and
a lens group having an optical axis accommodated in the lens barrel;
wherein the lens barrel comprises a first barrel wall provided with a light through hole and a second barrel wall bending and extending from an edge of the first barrel wall towards an image side along an optical axis direction,
the lens group comprises at least one first lens,
the first lens comprises a body portion serving as an imaging area and a peripheral portion outwards extending surrounding the body portion,
the peripheral portion is disposed opposite to the first barrel wall, and
the peripheral portion comprises an object-side surface and an image-side surface disposed opposite each other, and a connecting surface connecting the object-side surface and the image-side surface;
wherein one side of the first barrel wall close to the first lens is recessed towards a direction far away from the peripheral portion to form a first recess,
the object-side surface is recessed towards the image-side surface to form a second recess,
an orthographic projection of the first recess on the second recess coincides with the second recess, and the first recess and the second recess jointly enclose an accommodating space; and the lens module further comprises locating blocks which are clamped in the accommodating space and enable the first cone wall to be spaced apart from the peripheral portion.

2. The lens module according to claim 1, wherein the locating blocks are balls, and the first recess and the second recess are in arc-shaped structures.

3. The lens module according to claim 2, wherein the balls are symmetrically arranged along a circumferential direction of the peripheral portion.

4. The lens module according to claim 3, wherein the balls are equally spaced.

5. The lens module according to claim 2, wherein a plurality of first recesses are provided and spaced apart from each other, the number of the second recess is matched with that of the first recess, the first recess and the second recess disposed opposite to each other together enclose one accommodating space,
a plurality of balls are provided, and each ball is clamped in one accommodating space.

6. The lens module according to claim 1, wherein the lens group further comprises a second lens disposed on an image side of the first lens, and the lens module further comprises a shade sandwiched between the first lens and the second lens.

7. The lens module according to claim 6, wherein the shade is press-molded.

8. The lens module according to claim 1, wherein the connecting surface is abutted against the second barrel wall.
